(19) United States
(12) Patent Application Publication
(10) Pub. No.: US 2019/0389121 A1
(43) Pub. Date: Dec. 26, 2019

(54) METHOD FOR PRODUCING FILM AND FILM WINDING DEVICE

(71) Applicant: Sumitomo Chemical Company, Limited, Tokyo (JP)

(72) Inventors: Tatsuya KATAOKA, Niihama-shi (JP); Kiyomu NOMURA, Niihama-shi (JP); Fumiya KOMI, Niihama-shi (JP); Manabu OKAZAKI, Niihama-shi (JP)

(21) Appl. No.: 16/449,741

(22) Filed: Jun. 24, 2019

(30) Foreign Application Priority Data
Jun. 25, 2018 (JP) 2018-120044

(51) Int. Cl. B29C 53/56; B29C 53/80; B29C 53/82; H01M 2/14

(52) U.S. Cl. CPC B29C 53/56; B29C 53/8091; B29L 2031/3468; H01M 2/145; B29C 53/821

(57) ABSTRACT

A method for producing a film and a film winding device are provided. When transferring of the film is slowed for winding of the film to be suspended and after winding of the film is suspended, transferring of the film is accelerated for winding of the film to be resumed. The film has a tension at a first level during a period extending from slowing of transferring of the film to suspending of winding of the film. Alternatively, the film has a tension at a first level during a period extending from a predetermined time point during a period during which winding of the film is suspended to a time point at which the accelerating starts. The first level of the tension is higher than a second level that the tension has immediately before slowing of the transferring of the film starts.

This Nonprovisional application claims priority under 35 U.S.C. § 119 on Patent Application No. 2018-120044 filed in Japan on Jun. 25, 2018, the entire contents of which are hereby incorporated by reference.

### TECHNICAL FIELD

The present invention relates to (i) a method for producing a film and (ii) a device for winding the film.

### BACKGROUND ART

Patent Literature 1 discloses a device for transferring a wide web as a film, slitting the web into a plurality of strip-shaped webs, and winding each of the strip-shaped webs. Patent Literature 1 also discloses a method of stopping the transfer of a web and removing a defective portion from the rest of the web for removal of a defective portion of a web during the transfer.

### CITATION LIST

### Patent Literature

[Patent Literature 1]

Japanese Patent Application Publication, Tokukaihei, No. 9-29695 (Publication Date: Feb. 4, 1997)

### SUMMARY OF INVENTION

### Technical Problem

In a case where the transfer of a film by a film winding device is suspended for, for example, processing of the film and the transfer of the film is then resumed, the speed of the transfer of the film has conventionally been controlled in such a manner that increasing and decreasing the speed of transferring the film changes tension of the film. The resulting film roll may have a misaligned portion due to a change in the transfer tension of the film. The technique disclosed in Patent Literature 1 involves increasing and decreasing the speed of transfer of the entire web each time of removal of a defective portion of the web. The technique may thus cause a misaligned portion even in a roll of a web produced through the slitting operation and having no defective portion.

### Solution to Problem

In order to attain the above object, a method in accordance with an aspect of the present invention for producing a film is a method for producing a film, the method including the step of: (a) transferring a film and winding the film around at least one wind-up core, in a case where during the step (a), (i) the transferring of the film is slowed in order for the winding of the film to be suspended and (ii) after the winding of the film is suspended, the transferring of the film is accelerated in order for the winding of the film to be resumed, the film having a tension at a first level during a period extending from (i) a predetermined time point during a period during which the winding of the film is suspended to (ii) a time point at which the accelerating starts which first level is higher than a second level that the tension has immediately before the slowing of the transferring of the film starts.

In order to attain the above object, a method in accordance with an aspect of the present invention for producing a film is a method for producing a film, the method including the step of: (a) transferring a film and winding the film around at least one wind-up core, in a case where during the step (a), the transferring of the film is slowed in order for the winding of the film to be suspended, the film having a tension at a first level during a period extending from (i) a time point at which the slowing of the transferring of the film starts to (ii) a time point at which the suspending of the winding of the film ends which first level is not lower than a second level that the tension has immediately before the slowing of the transferring of the film starts.

In order to attain the above object, a film producing device in accordance with an aspect of the present invention is a film winding device for transferring a film and winding the film around a wind-up core, in a case where (i) the transferring of the film is slowed in order for the winding of the film to be suspended and (ii) after the winding of the film is suspended, the transferring of the film is accelerated in order for the winding of the film to be resumed, the film having a tension at a first level during a period extending from (i) a predetermined time point during a period during which the winding of the film is suspended to (ii) a time point at which the accelerating starts which first level is higher than a second level that the tension has immediately before the slowing of the transferring of the film starts.

In order to attain the above object, a film producing device in accordance with an aspect of the present invention is a film winding device for transferring a film and winding the film around a wind-up core, in a case where the transferring of the film is slowed in order for the winding of the film to be suspended, the film having a tension at a first level during a period extending from (i) a time point at which the slowing of the transferring of the film starts to (ii) a time point at which the suspending of the winding of the film ends which first level is not lower than a second level that the tension has immediately before the slowing of the transferring of the film starts.

### Advantageous Effects of Invention

An aspect of the present invention provides a method for winding a film and a film winding device each of which (i) alleviates a change in the tension of a film which change is caused by suspension and resumption of transfer of the film and thereby (ii) reduces misalignment of the film in the form of a roll.

### BRIEF DESCRIPTION OF DRAWINGS

FIG. 1 provides diagrams illustrating how the speed of transfer and tension of a separator are changed over time for a method according to Embodiment 1 of the present invention for winding a separator.

FIG. 2 provides schematic views of a separator winding device according to Embodiment 1 of the present invention.

FIG. 3 illustrates a flowchart of an example of how a separator is wound by a method according to Embodiment 1 of the present invention.

FIG. 4 provides diagrams illustrating how the speed of transfer and tension of a separator are changed over time for a method according to a comparative embodiment for winding a separator.

FIG. 5 provides diagrams illustrating how the speed of transfer and tension of a separator are changed over time for a method according to Embodiment 2 of the present invention for winding a separator.

### DESCRIPTION OF EMBODIMENTS

### Embodiment 1

The present specification describes, as an example method for producing a film, a method for producing a nonwoven fabric or porous film, in particular, a separator for use in, for example, a lithium-ion secondary battery.

A separator is a porous film or nonwoven fabric that separates the positive electrode and negative electrode of, for example, a lithium-ion secondary battery (battery) from each other and that allows lithium ions to move between the positive electrode and the negative electrode. A separator contains, for example, a polyolefin such as a polyethylene or a polypropylene as a material.

A separator may include a porous film and a functional layer on a surface of the porous film. Examples of the functional layer include (i) a heat-resistant layer that imparts heat resistance to the separator and (ii) an adhesive layer that imparts adhesiveness to the separator. The heat-resistant layer contains, for example, a wholly aromatic polyamide (aramid resin) and/or polyvinylidene fluoride (fluorocarbon resin) as a material.

A separator may be a laminated porous film including (i) a porous film containing a polyolefin and (ii) a functional layer(s) such as a heat-resistant layer and an adhesive layer. The functional layer contains a resin. Examples of the resin include: a polyolefin such as polyethylene or polypropylene; a fluorine-containing polymer such as polyvinylidene fluoride (PVDF), polytetrafluoroethylene, or a PVDF-hexafluoropropylene copolymer; an aromatic polyamide; a rubber such as a styrene-butadiene copolymer or a hydride thereof, a methacrylate ester copolymer, an acrylonitrile-acrylic ester copolymer, or a styrene-acrylic ester copolymer; a polymer having a melting point or glass transition temperature of not lower than 180° C.; and a water-soluble polymer such as polyvinyl alcohol, polyethylene glycol, cellulose ether, sodium alginate, polyacrylic acid, polyacrylamide, or polymethacrylic acid.

The functional layer may contain a filler made of an inorganic substance or organic substance. The inorganic filler is made of, for example, an inorganic oxide such as silica, magnesium oxide, alumina, aluminum hydroxide, or boehmite. While alumina has crystal forms such as α-alumina, β-alumina, γ-alumina, and θ-alumina, the inorganic filler for the present embodiment may be made of any of the crystal forms.

The functional layer may contain (i) only one kind of resin and/or filler or (ii) two or more kinds of resins and/or fillers in combination. In a case where the functional layer contains a filler, the filler may be contained in an amount of not less than 1% by volume and not more than 99% by volume of the functional layer.

The present embodiment described below is suitably applicable to (i) a film having a film thickness of not more than 100 μm and more susceptible to the influence of an increase or decrease in the transfer speed or (ii) a film having a pore(s) or void(s). The present embodiment is, in particular, more suitably applicable to (i) a film having a film thickness within a range of 5 μm to 50 μm or (ii) a film having a pore(s) or void(s) at a rate within a range of 30% to 60% with respect to the area of a surface of the film. The present embodiment is even more suitably applicable to a film having the above film thickness and a pore(s) or void(s) at the above rate.

The present embodiment is suitably applicable to, as a separator, (i) a porous film containing a polyolefin and having the above film characteristics or (ii) a laminated porous film including a porous film containing a polyolefin and a functional layer(s). The functional layer is, in particular, suitably a functional layer having a total film thickness within a range of 1 μm to 10 μm. In a case where the functional layer(s) contains a filler, the filler is contained in an amount of not less than 1% by volume and not more than 99% by volume of the functional layer. The filler is suitably alumina or boehmite.

A method in accordance with the present embodiment for producing a separator includes a step of winding a separator around a wind-up core with use of a separator winding device as a film winding device for the present embodiment. The winding step includes a step of slitting a wide separator original sheet into a plurality of slit separators as strip-shaped films each having a predetermined width such as a product width.

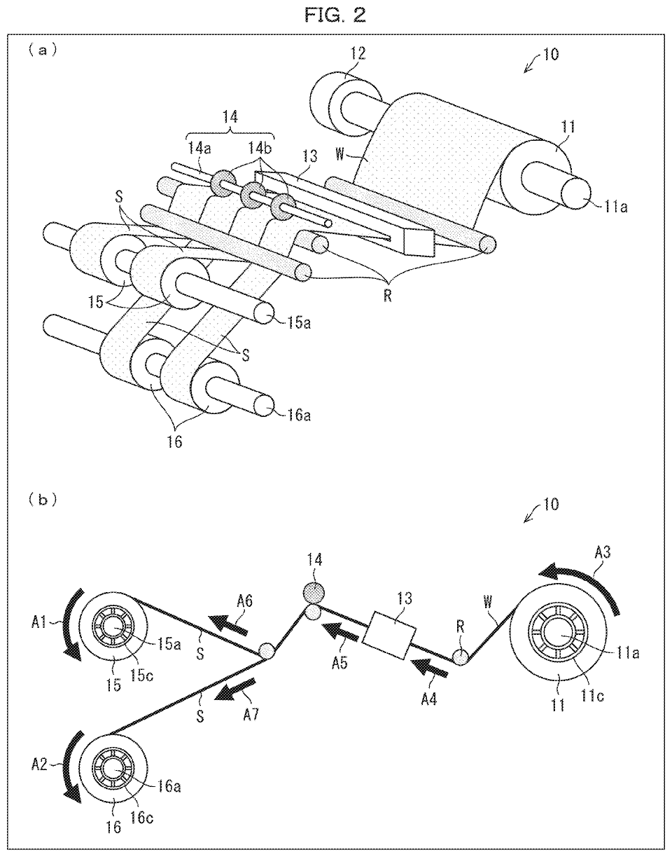

FIG. 2 provides schematic views of a separator winding device 10 in accordance with the present embodiment. (a) of FIG. 2 is a perspective view of the separator winding device 10. (b) of FIG. 2 is side view of the separator winding device 10. (a) and (b) of FIG. 2 each omit a component(s) for simple illustration.

As illustrated in (a) and (b) of FIG. 2, the separator winding device 10 includes a wind-off section 11, a wind-off control section 12, an inspection section 13, a slitter 14, a plurality of wind-up sections 15 and 16, and a plurality of rollers R.

The wind-off section 11 includes a wind-off shaft 11a and a wind-off core 11c. The wind-off core 11c has an outer peripheral surface on which a wide separator original sheet W produced through a conventional process is wound. The wind-off shaft 11a is fitted in the wind-off core 11c. Rotating the wind-off shaft 11a rotates the wind-off core 11c, which causes the separator original sheet W around the wind-off core 11c to be wound off.

For the present embodiment, the wind-off shaft 11a may be a driven shaft. The wind-off shaft 11a and the wind-off core 11c may be configured, for instance, to be rotated in the direction indicated with arrow A3 as the wind-up sections 15 and 16 (described later) rotate in the directions indicated with arrows A1 and A2, respectively, to pull the separator original sheet W. The present embodiment is, however, not limited to such a configuration. The wind-off shaft 11a may be a driving shaft. The wind-off shaft 11a may be, for instance, connected to a motor (not shown), which drives the wind-off core 11c to rotate in the direction indicated with arrow A3 to cause the separator original sheet W to be wound off.

The wind-off control section 12 is connected to the wind-off shaft 11a, and is capable of controlling torque to the wind-off shaft 11a. The wind-off control section 12 may be, for example, a powder brake for controlling torque for braking the rotating wind-off shaft 11a. In this case, the wind-off control section 12 is, by braking the rotating wind-off shaft 11a, capable of controlling the rotation of the wind-off shaft 11a and the wind-off core 11c and thereby controlling the transfer tension of the separator original sheet W.

The inspection section 13 is positioned on the transfer path of the separator original sheet W wound off from the wind-off section 11. While the separator original sheet W is being transferred in the direction indicated with arrow A4, the inspection section 13 inspects the passing separator original sheet W for a defect, for example. The inspection may be a conventional inspection for a separator defect: The inspection may be carried out visually by an operator or automatically with use of a sensor. For the present embodiment, a defect may result from, for example, a coating being peeling off from the rest of the separator original sheet W or a hole being made in the base material of the separator original sheet W during production of the separator original sheet W.

The slitter 14 includes a cutter shaft 14a and a plurality of cutters 14b fitted on the cutter shaft 14a. The slitter 14 uses the plurality of cutters 14b to slit the wide separator original sheet W in the direction indicated with arrow A5 (in which the separator original sheet W is transferred) into a plurality of strip-shaped slit separators S each having a predetermined width. (a) of FIG. 2 illustrates the slitter 14 slitting a separator original sheet W into four slit separators S. The present embodiment may alternatively be configured to slit a separator original sheet W into more than four slit separators S.

The present embodiment is configured to transfer each of the plurality of slit separators S in the direction indicated with arrow A6 or A7 to be wound around the wind-up section 15 or 16.

The wind-up section 15 includes a wind-up shaft 15a and a plurality of wind-up cores 15c. The plurality of wind-up cores 15c each have an outer peripheral surface on which one of the plurality of slit separators S is to be wound. The wind-up shaft 15a is fitted in the wind-up cores 15c. Rotating the wind-up shaft 15a rotates the wind-up cores 15c, which causes each slit separator S to be wound around one of the wind-up cores 15c.

For the present embodiment, the wind-up shaft 15a is a driving shaft. The wind-up shaft 15a may be, for instance, connected to a motor (not shown), which drives each wind-up core 15c to rotate in the direction indicated with arrow A1 to wind a slit separator S.

The wind-up section 16 may be identical in configuration to the wind-up section 15 except for the position. In this case, the wind-up shaft 16a may be, for instance, connected to a motor (not shown), which drives each wind-up core 16c to rotate in the direction indicated with arrow A2 to wind a slit separator S. The wind-up shafts 15a and 16a are rotated at respective rates controlled so that the wind-up shafts 15a and 16a wind slit separators S at respective rates equal to each other.

The plurality of rollers R are each a rotary shaft for guiding the separator original sheet W or slit separators S. The plurality of rollers R are each a driven shaft.

The separator original sheet W or slit separators S may be transferred at a speed controlled through control of (i) the rate of rotation of each of the wind-up shafts 15a and 16a and (ii) the force with which the wind-off control section 12 brakes the rotating wind-off shaft 11a. The speed of the transfer of the separator original sheet W or slit separators S may, for instance, be increased by (i) increasing the rate of rotation of each of the wind-up shafts 15a and 16a or (ii) weakening the force of braking the wind-off shaft 11a.

The tension of the separator original sheet W or slit separators S may be controlled similarly. For instance, the tension of the separator original sheet W or slit separators S may be increased by strengthening the force with which the wind-off control section 12 brakes the wind-off shaft 11a. For the present embodiment, the tension of the separator original sheet W or slit separators S being transferred is substantially equal at any position.

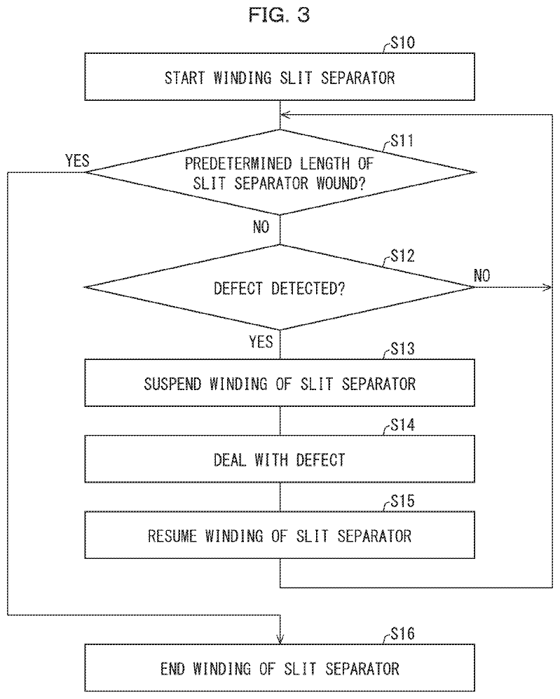

FIG. 3 illustrates a flowchart of an example of how the separator winding device 10 in accordance with the present embodiment winds slit separators S. With reference to FIGS. 2 and 3, the description below deals with a step in accordance with the present embodiment of winding slit separators S.

First, the respective wind-up shafts 15a and 16a of the wind-up sections 15 and 16 are driven to start winding slit separators S around the wind-up cores 15c and 16c (step S10). This causes a separator original sheet W wound around the wind-off core 11c of the wind-off section 11 to be pulled and wound off from the wind-off section 11. The separator original sheet W wound off from the wind-off section 11 is inspected by the inspection section 13 for a defect, and is then slit by the slitter 14 into a plurality of slit separators S.

The length by which each slit separator S is wound is calculated on the basis of, for example, the number of rotations of each of the wind-up cores 15c and 16c. Each slit separator S is wound by a predetermined length (step S11).

While the slit separators S are being wound, the separator original sheet W is inspected by the inspection section 13 for a defect (step S12). The separator winding device 10 repeats steps S11 and S12 until the inspection section 13 finds a defect.

If the inspection section 13 has detected a defect, the separator winding device 10 suspends the winding of the slit separators S (step S13). This means that the separator winding device 10 suspends the transfer of the separator original sheet W or slit separators S as well. Next, the defect is dealt with (step S14). Examples of such an operation include marking the defective portion with ink or tape, repairing the defect, and removing the defect.

Next, the separator winding device 10 increases the speed of the winding of the slit separators S until the speed of transfer of the separator original sheet W or slit separators S reaches a level of normal winding (that is, the transfer speed immediately before the separator winding device 10 started decreasing the transfer speed to suspend the winding) to resume the winding (step S15). The process then returns to step S11, and the separator winding device 10 continues to wind the slit separators S.

If the separator winding device 10 has determined in step S11 that the slit separators S have been wound by not less than a predetermined length, the separator winding device 10 stops the winding of the slit separators S (step S16). This means that the separator winding device 10 stops the transfer of the separator original sheet W or slit separators S as well. This ends the step of winding slit separators S.

The description below deals with how the transfer speed and tension of a separator original sheet W or slit separators S are changed over time during the above-described step of winding slit separators S. In the description below, the expressions “transfer speed” and “tension” with no subsequent modifier refer respectively to those of a separator original sheet W or slit separators S.

The separator winding device 10 suspends the winding not only for a defect to be dealt with, but also for production trouble or replacement of a wind-up core during the operation. Examples of the production trouble include a power failure and a device malfunction.

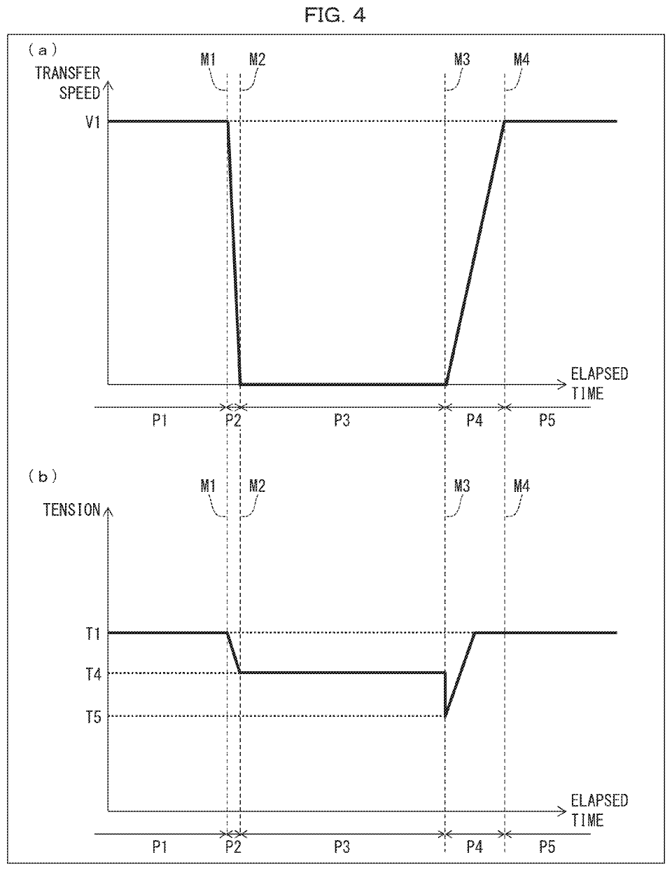

FIG. 4 provides diagrams illustrating how a transfer speed and tension are changed over time during a step according to a comparative embodiment of winding slit separators S The step according to the comparative embodiment of winding slit separators S includes a winding step included in a conventional method for producing slit separators. (a) and (b) of FIG. 4 each have a horizontal axis indicative of the elapsed time during the winding step. The respective horizontal axes of (a) and (b) of FIG. 4 indicate a common elapsed time. (a) of FIG. 4 has a vertical axis indicative of the transfer speed. (b) of FIG. 4 has a vertical axis indicative of the tension. FIG. 4 shows how the transfer speed and tension are changed from a time point before suspension of the winding of a separator original sheet W or slit separators S through to a time period after resumption of the winding.

FIG. 4 shows a period P1, during which slit separators S are wound normally. FIG. 4 also shows V1 to indicate the transfer speed during the normal winding of slit separators S and T1 to indicate the tension during the normal winding of slit separators S. The present embodiment and comparative embodiment are each arranged to wind slit separators S at the transfer speed of V1 constantly during the period P1. The comparative embodiment is, however, not limited to such an arrangement. The comparative embodiment may be arranged to, for instance, gradually increase or decrease the transfer speed according to the length by which slit separators S are wound. The comparative embodiment may also be arranged to change the transfer speed at the start or end of winding slit separators S.

The separator winding device of the comparative embodiment carries out step S13 at a time point M1. This causes the winding step to transition to a period P2. The period P2 of the comparative embodiment sees a decrease in the transfer speed and a decrease in the tension from T1 to T4. This is because the wind-off control section 12 is incapable of controlling the braking force to the wind-off shaft 11a in such a manner as to strictly follow a decrease in the transfer speed. The decrease in the tension thus tends to be larger as the decrease in the transfer speed during the period P2 is larger.

For better productivity, the period P2 should desirably be not longer than 1 minute in a case where the transfer speed V1 during the period P1 is not less than 50 m/min. The period P2 should be not longer than 10 minutes, preferably not longer than 5 minutes, more preferably not longer than 3 minutes, in a case where the transfer speed V1 during the period P1 is not less than 100 m/min. The period P2 thus typically sees a sharp drop in the relative transfer speed, with the likely result of a decrease in the tension.

The period P2 ends at a time point M2, at which the separator winding device suspends the transfer of the separator original sheet W or slit separators S. The period P2 is followed by a period P3, during which step S14 is carried out. The tension is kept at T4 during the period P3.

The period P3 ends at a time point M3, at which the separator winding device ends the suspension of the transfer of the separator original sheet W or slit separators S. The separator winding device then carries out step S15 during a period P4. The period P4 sees an increase in the transfer speed to V1. The tension is decreased further from T4 to T5 at the time point M3 (that is, when the period P3 ends and the period P4 starts). This is due to a lack of synchronization, at the time point of resumption of the winding of the slit separators S, between (i) driving of the wind-up shafts 15a and 16a and (ii) control of the braking force applied by the wind-off control section 12 to the wind-off shaft 11a.

During the period P4, the control of the braking force applied by the wind-off control section 12 to the wind-off shaft 11a becomes gradually capable of following a change in the transfer speed, with the result of the tension increasing from T5 to T1. The increase in the transfer speed ends at a time point M4, at which a period P5 starts. The separator winding device winds the slit separators S normally again from the start of the period P5 onward.

The tension is decreased from T1 (which is the tension during the normal winding, that is, the tension immediately before the time point M1 [at which the decrease in the transfer speed starts]) to T4 at the time point M2 (that is, when the period P2 ends and the period P3 starts). The tension is kept at T4 during the period P3 (that is, while the separator winding device is suspending the winding of the slit separators S). The tension is decreased further from T4 to T5 at the time point M3.

The time point M3 (that is, the time point at which the separator winding device resumes the winding of the slit separators S) does not see a perfect synchronization between the driving of the wind-up shafts 15a and 16a and the control of the braking force applied by the wind-off control section 12 to the wind-off shaft 11a. Thus, in a case where the tension at the time point M3 is lower than during the normal winding, the separator original sheet W or slit separators S may become loose. Such looseness may result in a slit separator S being misaligned in the width direction at the wind-up section 15 or 16. Misalignment similar to the above may occur at the time point M2, at which the separator winding device suspends the winding of the slit separators S.

The above misalignment causes a roll of a slit separator S on the wind-up section 15 or 16 to have uneven side surfaces, with the result of the roll having poor appearance. Further, if the slit separator S is wound off from the roll of the misaligned slit separator S for use in production of secondary batteries, the widthwise misalignment of the separator may result in the separator being misaligned in a battery. Using a roll of a misaligned slit separator S for production of batteries thus leads to a decrease in the yield during the process of producing the batteries.

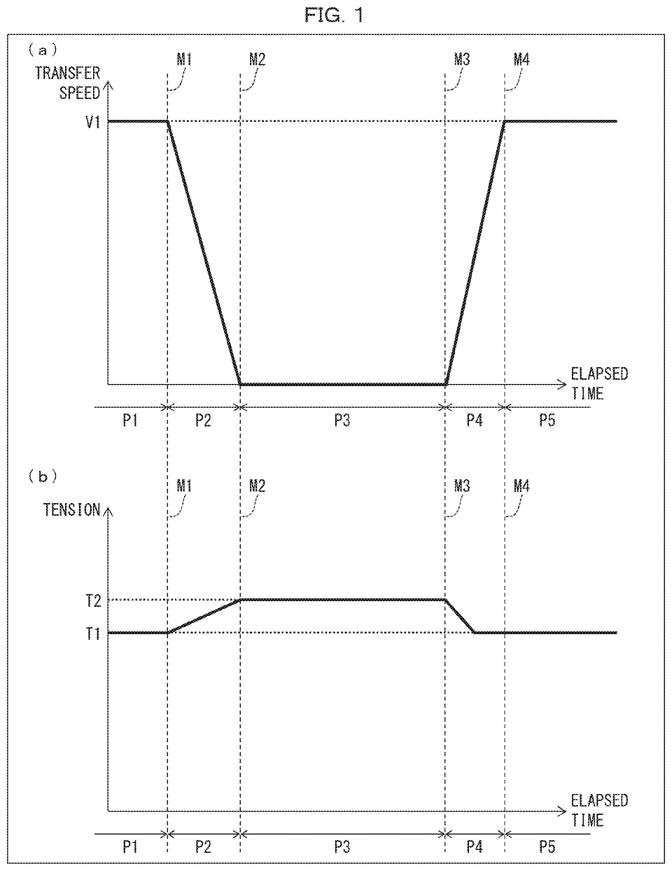

FIG. 1 provides diagrams illustrating how a transfer speed and tension are changed over time during a step according to the present embodiment of winding slit separators S. (a) and (b) of FIG. 1 correspond respectively to (a) and (b) of FIG. 4. FIG. 1 shows periods P1 to P5, which correspond respectively to the periods P1 to P5 in FIG. 4. FIG. 1 shows time points M1 to M4, which correspond respectively to the time points M1 to M4 in FIG. 4.

The present embodiment involves a step of winding slit separators S which step differs from that of the comparative embodiment in how the tension is controlled from the period P2 to the period P4. The step according to the present embodiment of winding slit separators S may be carried out similarly to that of the comparative embodiment except for the above point.

The step according to the present embodiment of winding slit separators S is carried out as follows: In a case where the separator winding device has detected a defect in the separator original sheet W, the process transitions from the period P1 to the period P2, when the separator winding device suspends the winding of the slit separators S. The period P2 may be longer than that of the comparative embodiment.

The step according to the present embodiment of winding slit separators S is arranged such that at the time point M2 (that is, at the time point at which the separator winding device suspends the winding of the slit separators S), the tension is increased from T1 to T2. This arrangement may be achieved by increasing the braking force (which is applied by the wind-off control section 12 to the wind-off shaft 11a) during the period P2 over the level of the braking force applied immediately before the time point M1 (that is, immediately before the separator winding device starts decreasing the speed of the transfer of the separator original sheet W or slit separators S).

The period P2 is followed by the period P3, during which step S14 is carried out similarly to the winding step of the comparative embodiment. The present embodiment is arranged such that the tension during the period P3 is kept at T2.

The separator winding device then resumes the winding of the slit separators S at the time point M3 (that is, when the process transitions from the period P3 to the period P4) while keeping the tension at T2. During the period P4 (that is, after the separator winding device resumes the winding of the slit separators S), the separator winding device increases the braking force (which is applied by the wind-off control section 12 to the wind-off shaft 11a) back to the level of the braking force applied immediately before the time point M1 (that is, during the normal winding). The tension is thus decreased from T2 back to T1 during the period P4. The process then transitions to the period P5 at the time point M4 similarly to the winding step of the comparative embodiment.

The step according to the present embodiment of winding slit separators S is carried out in such a manner as to keep the tension at not lower than T1 (which is the tension during the normal winding) from (i) the time point at which the separator winding device starts decreasing the speed of the transfer of a separator original sheet W or slit separators S to (ii) the time point at which the separator winding device ends the suspension of the winding of the slit separators S. The present embodiment is, in other words, arranged such that the tension during the period between the time points M1 and M3 is kept at a level not lower than the level immediately before the time point M1.

Further, the step according to the present embodiment of winding slit separators S is carried out in such a manner that the tension is T2, which is higher than T1 (which is the tension during the normal winding), from a predetermined time point to the time point of the start of an increase in the speed during the period during which the separator winding device is suspending the transfer of the separator original sheet W or slit separators S. The present embodiment is arranged such that the tension during the period between the time points M2 and M3 is kept at a level not lower than the level immediately before the time point M1.

The above arrangement allows the separator winding device to, when resuming the winding, reduce misalignment of a slit separator S at the wind-up section 15 or 16 which misalignment is caused by looseness of the separator original sheet W or slit separators S. Increasing the tension at the time point at which the separator winding device starts the suspension makes it easy to control the braking force applied by the wind-off control section 12 to the wind-off core 11c.

The present embodiment is arranged such that the tension during the period between the time points M1 and M3 is kept at a level not lower than the level immediately before the time point M1. This allows the separator winding device to, also when suspending the winding, reduce misalignment of a slit separator S at the wind-up section 15 or 16 which misalignment is caused by looseness of the separator original sheet W or slit separators S.

The present embodiment is arranged to increase the tension from T1 to T2 gradually from the time point M1 to the time point M2 as illustrated in (b) of FIG. 1. The present embodiment is, however, not limited to such an arrangement, and is simply arranged such that the tension is controlled so as to be not lower than T1 at the time point M2. For instance, the tension may be increased from T1 to T2 at the time point M2 or gradually from the period P2 to a time point during the period P3.

The present embodiment is, as illustrated in (b) of FIG. 1, preferably arranged such that the tension during the period from the time point M3 to the time point M4 (at which the separator winding device ends increasing the speed of the transfer of a separator original sheet W or slit separators S) is at a level not lower than the level immediately before the time point M1. This allows the separator winding device to increase the speed of the transfer of a separator original sheet W or slit separators S under a more appropriate tension.

T2 is higher than T1 by preferably not less than 2.5%, more preferably not less than 5%, to sufficiently prevent a separator original sheet W or slit separators S from becoming loose. T2 is higher than T1 by preferably not more than 17.5%, more preferably not more than 15%, to prevent a separator original sheet W or slit separators S from being deformed by an increase in the tension. This effect of preventing deformation caused by an increase in the tension is particularly remarkable for a film that can be deformed greatly by an increase in the tension, for example, a film including a porous film such as a secondary battery separator.

The method according to the present embodiment for producing a film is remarkably effective for, specifically, a polyolefin porous layer film (separator) having a small film thickness within a range of 5 μm to 30 μm and a high porosity within a range of 30% to 60%.

The method according to the present embodiment for producing a film is particularly effective for, among other porous layer films, a porous layer film containing an ultra-high molecular weight polyethylene as a polyolefin. The method according to the present embodiment for producing a film is more effective for a porous layer film containing an ultra-high molecular weight polyethylene in an amount of more than 50% by weight. The above effect is even more remarkable for a porous layer film containing a rigid ultra-high molecular weight polyethylene because such a film is highly resistant to a cutter during the slitting operation.

The method according to the present embodiment for producing a film is also effective for a laminated porous film (separator) including the above-described polyolefin porous film and a functional layer on the porous film which functional layer has a thickness-based mechanical strength smaller than that of the above-described polyolefin porous film. This is because whether a film is deformed depends mainly on the polyolefin porous film included in that film.

A porous film (separator) including a functional layer containing at a surface thereof a filler made of an inorganic substance such as silica, magnesium oxide, alumina, aluminum hydroxide, and boehmite is harder than a porous film made only of an organic substance. The above effect is more remarkable for a porous film containing the above filler because such a porous film is highly resistant to a cutter during the slitting operation. The above effect is even more remarkable for a porous film including a functional layer containing a wholly aromatic polyamide because a wholly aromatic polyamide has high rigidity, and such a porous film is thus highly resistant to a cutter during the slitting operation.

Example slitting methods include a razor-cutting method, which involves use of a razor blade, and a shear-cutting method, which involves use of a shear blade including an upper blade and a lower blade (specifically, which involves cutting a film with use of the upper and lower blades while supporting the film with use of the upper and lower blades). Of the two, the razor-cutting method is more susceptible to a decreased tension because the razor-cutting method involves cutting a film without supporting the film with use of a lower blade. The method according to the present embodiment for producing a film is thus particularly remarkably effective for a slitter device based on the razor-cutting method.

### Embodiment 2

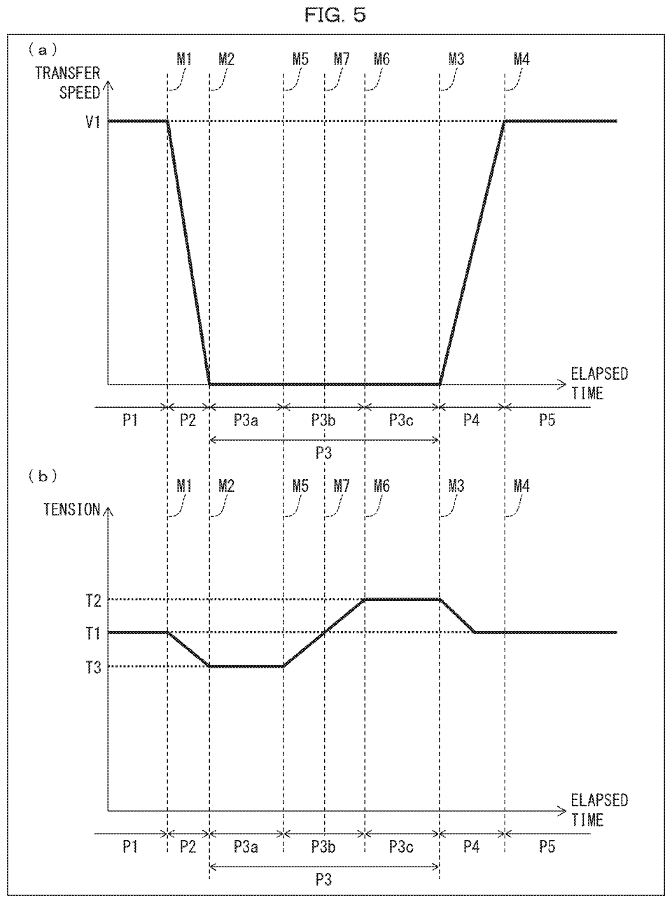

FIG. 5 provides diagrams illustrating how a transfer speed and tension are changed over time during a step according to the present embodiment of winding slit separators S. (a) and (b) of FIG. 5 correspond respectively to (a) and (b) of FIG. 1. FIG. 5 shows periods P1 to P5, which correspond respectively to the periods P1 to P5 in FIG. 1. FIG. 5 shows time points M1 to M4, which correspond respectively to the time points M1 to M4 in FIG. 1.

The present embodiment involves a step of winding slit separators S which step differs from that of the preceding embodiment in how the tension is controlled from the period P2 to the period P4. The present embodiment is further arranged to control the tension differently during each of the three periods P3a to P3c, into which the period P3 is divided. The step according to the present embodiment of winding slit separators S may be carried out similarly to that of the preceding embodiment except for the above point.

The step according to the present embodiment of winding slit separators S is similar to that of the preceding embodiment up to the time point M1. The separator winding device of the present embodiment is arranged to decrease the tension from T1 to T3 during the period P2, that is, the period extending from the time point M1 to the time point M2. The present embodiment may have a period P2 shorter than that of the preceding embodiment.

The separator winding device then keeps the tension at T3 during the time period P3a, that is, the period extending from the time point M2 to a time point M5. The separator winding device then increases the tension from T3 to T2 during the period P3b, that is, the period extending from the time point M5 to a time point M6. The separator winding device may increase the tension by gradually increasing the braking force from the time point M5 (for example, by rotating the wind-off section in the opposite direction). This causes the tension to become not less than T1 at a time point M7 during the period P3b. The separator winding device then keeps the tension at T2 during the period P3c, that is, the period extending from the time point M6 to the time point M3.

Similarly to the preceding embodiment, the separator winding device then resumes the winding of the slit separators S at the time point M3 (that is, when the process transitions from the period P3 to the period P4) while keeping the tension at T2. During the period P4 (that is, after the separator winding device resumes the winding of the slit separators S), the separator winding device increases the braking force (which is applied by the wind-off control section 12 to the wind-off shaft 11a) back to the level of the braking force applied immediately before the time point M1 (that is, during the normal winding). The tension is thus decreased from T2 back to T1 during the period P4. The process then transitions to the period P5 at the time point M4 similarly to the preceding embodiment.

Further, the step according to the present embodiment of winding slit separators S is carried out in such a manner that the tension is T2, which is higher than T1 (which is the tension during the normal winding), from a predetermined time point to the time point of the start of an increase in the speed during the period during which the separator winding device is suspending the transfer of the separator original sheet W or slit separators S. The present embodiment is arranged such that the tension during the period between the time points M7 and M3 is kept at a level not lower than the level immediately before the time point M1.

The present embodiment is arranged to increase the tension at a predetermined time point during the suspension. This arrangement, similarly to the preceding embodiment, also reduces the risk of a slit separator S being misaligned when the separator winding device resumes the winding.

A device according to each embodiment described above of the present invention for winding a film is usable as a device including a wind-off section and a wind-up section such as (i) a slitter device for slitting a wide film into strip-shaped films, (ii) a device for inspecting a film, and (iii) a device for winding a film around another core to replace a core or adjust the winding length. A method according to each embodiment described above of the present invention is usable as a method for producing a film which method involves use of the above device for producing a film.

### Examples

A plurality of slit separators were produced under various production conditions applied during the slitting operation as described below. The plurality of slit separators were compared with one another for evaluation as described below.

### <Porous Film>

First, 68% by weight of ultra-high molecular weight polyethylene powder (GUR2024, available from Ticona Corporation) and 32% by weight of polyethylene wax (FNP-0115, available from Nippon Seiro Co., Ltd.) having a weight-average molecular weight of 1,000 were mixed with each other to prepare 100 parts by weight of a mixture.

Next, 0.4% by weight of an antioxidant (Irg1010, available from Ciba Specialty Chemicals Corporation), 0.1% by weight of an antioxidant (P168, available from Ciba Specialty Chemicals Corporation), and 1.3% by weight of sodium stearate were added to the mixture. Further, calcium carbonate having an average pore diameter of 0.1 μm was added to the mixture so as to account for 38% by volume with respect to the total volume of the mixture.

Next, the above mixture was mixed in powder form and melt-kneaded with use of a twin screw kneading extruder. This produced a polyolefin resin composition. The polyolefin resin composition was rolled into a sheet with use of a pair of rolls each having a surface temperature of 150° C. This sheet was immersed in an aqueous hydrochloric acid solution (containing 4 mol/L of hydrochloric acid and 0.5% by weight of nonionic surfactant) for removal of the calcium carbonate from the sheet. The sheet was then stretched 6-fold at 105° C. This produced a porous film having a film thickness of 14 μm and a porosity of 50%.

### <Production of Separator>

Poly(paraphenylene terephthalamide) was prepared. 2200 parts by weight of N-methyl-2-pyrrolidone (NMP) was charged into a reaction container in a nitrogen atmosphere. 151.07 parts by weight of vacuum-dried calcium chloride powder was added to the reaction container. The reaction container was heated to 100° C. so that the calcium chloride was dissolved entirely.

Next, the reaction container was cooled to room temperature. 68.23 parts by weight of paraphenylenediamine was then added to the reaction container and was dissolved entirely. While the solution was kept at a temperature of 20° C.±2° C., 124.97 parts by weight of dichloride terephthalate was added to the reaction container, and the solution was stirred.

Next, the solution was filtered through a 1500-mesh stainless-steel net. The resulting solution contained para-aramid at a concentration of 6%. 100 parts by weight of the para-aramid solution was weighed out into another container. 300 parts by weight of NMP was added to the para-aramid solution. This prepared a solution containing para-aramid at a concentration of 1.5% by weight.

Next, 6 parts by weight of Alumina C (available from Nippon Aerosil Co., Ltd.) and 6 parts by weight of Advanced Alumina AA-03 (available from Sumitomo Chemical Co., Ltd.) were mixed with the solution containing para-aramid at a concentration of 1.5% by weight. The resulting solution was filtered through a 1000-mesh wire net. Then, 0.73 parts by weight of calcium oxide was added to the solution. The resulting solution was stirred for neutralization. The solution was then degassed under reduced pressure. This prepared a coating solution in slurry form.

The coating solution was applied to a surface of the above porous film. The calcium oxide was let deposit in an atmosphere having a temperature of 50° C. and a humidity of 70%. The porous film was washed with running water. The porous film was then dried in a dryer at 70° C. for formation of a functional layer. This produced an original sheet of a laminated separator for a nonaqueous electrolyte secondary battery.

### <Slitting of Separator>

The above separator original sheet was cut into strips with use of a slitter while the separator original sheet was transferred at a speed of 100 m/min which transfer was suspended and resumed. A 6 cm-wide strip was wound around a wind-up core by the length of 2000 m. This produced a separator having a film thickness of 17 μm. The production conditions during the slitting operation were changed variously. This produced rolls of respective slit separators of Examples 1 to 6 and Comparative Examples 1 and 2.

Tables 1 and 2 show the production conditions during the slitting operation and the rates of misaligned products for the respective Examples and Comparative Examples.

Table 1 shows “Tension increase rate during period P2”, which indicates how much the tension increased during the period P2 (during which the separator winding device decreased the speed of transfer of a separator original sheet W or slit separators S) over the level of the tension applied immediately before the time point M1 (that is, immediately before the separator winding device started to decrease the transfer speed). Table 2 shows “Tension increase rate at time point M3”, which indicates how much the tension increased at the time point M3 (at which the separator winding device resumed the transfer of the separator original sheet W or slit separators S) over the level of the tension applied immediately before the time point M1 (that is, immediately before the separator winding device started to decrease the transfer speed).

Tables 1 and 2 each show “Rate of misaligned products”, which indicates the rate of rolls with commercially untolerable misalignment over all the rolls produced. Tables 1 and 2 each show “Evaluation”, which indicates how the production process of each of the Examples and Comparative Examples was evaluated on the basis of the rate of misalignment.

TABLE 1

| | Tension increase | Rate of | |
|---|---|---|---|
| | rate during | misaligned | |
| | period P2 | products | Evaluation |
| Comparative Example 1 | 0% | 6% to 10% | Poor |
| Example 1 | 5% | 3% to 5% | Good |
| Example 2 | 10% | 2% or less | Excellent |
| Example 3 | 15% | 2% or less | Excellent |

TABLE 2

| | Tension increase | Rate of | |
|---|---|---|---|
| | rate at time | misaligned | |
| | point M3 | products | Evaluation |
| Comparative Example 2 | 0% | 6% | Poor |
| Example 4 | 5% | 3% | Good |
| Example 5 | 10% | 1% | Excellent |
| Example 6 | 15% | 1% | Excellent |

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

10 Separator winding device
11 Wind-off section
12 Wind-off control section
13 Inspection section
14 Slitter
15, 16 Wind-up section
W Separator original sheet
S Slit separator

1. A method for producing a film, the method comprising the step of:
(a) transferring a film and winding the film around at least one wind-up core,
in a case where during the step (a), (i) the transferring of the film is slowed in order for the winding of the film to be suspended and (ii) after the winding of the film is suspended, the transferring of the film is accelerated in order for the winding of the film to be resumed, the film having a tension at a first level during a period extending from (i) a predetermined time point during a period during which the winding of the film is suspended to (ii) a time point at which the accelerating starts which first level is higher than a second level that the tension has immediately before the slowing of the transferring of the film starts.

2. The method according to claim 1, wherein
during the step (a), the first level is higher than the second level by 2.5% to 17.5%.

3. The method according to claim 1, wherein
the predetermined time point is a time point at which the suspending of the winding of the film starts.

4. A method for producing a film, the method comprising the step of:
(a) transferring a film and winding the film around at least one wind-up core,
in a case where during the step (a), the transferring of the film is slowed in order for the winding of the film to be suspended, the film having a tension at a first level during a period extending from (i) a time point at which the slowing of the transferring of the film starts to (ii) a time point at which the suspending of the winding of the film ends which first level is not lower than a second level that the tension has immediately before the slowing of the transferring of the film starts.

5. The method according to claim 1, wherein
the step (a) includes a step (b) of slitting the film in a direction of the transferring of the film into a plurality of strip-shaped films,
the at least one wind-up core includes a plurality of wind-up cores, and
during the step (a), the plurality of strip-shaped films are each wound around one of the plurality of wind-up cores.

6. The method according to claim 1, wherein
the film is a separator for a secondary battery.

7. A film winding device for transferring a film and winding the film around a wind-up core,
in a case where (i) the transferring of the film is slowed in order for the winding of the film to be suspended and (ii) after the winding of the film is suspended, the transferring of the film is accelerated in order for the winding of the film to be resumed, the film having a tension at a first level during a period extending from (i) a predetermined time point during a period during which the winding of the film is suspended to (ii) a time point at which the accelerating starts which first level is higher than a second level that the tension has immediately before the slowing of the transferring of the film starts.

8. A film winding device for transferring a film and winding the film around a wind-up core,
in a case where the transferring of the film is slowed in order for the winding of the film to be suspended, the film having a tension at a first level during a period extending from (i) a time point at which the slowing of the transferring of the film starts to (ii) a time point at which the suspending of the winding of the film ends which first level is not lower than a second level that the tension has immediately before the slowing of the transferring of the film starts.
